(19) United States
(12) Patent Application Publication
(10) Pub. No.: US 2002/0132146 A1
(43) Pub. Date: Sep. 19, 2002

(54) Method and system for starting a fuel cell stack of a fuel cell installation

(76) Inventor: Konrad Mund, Uttenreuth (DE)

Correspondence Address: LERNER AND GREENBERG, P.A., Post Office Box 2480, Hollywood, FL, 33022-2480, US

(21) Appl. No.: 10/105,558

(22) Filed: Mar. 25, 2002

Related U.S. Application Data
(63) Continuation of application No. PCT/DE00/03178, filed on Sep. 13, 2000.

(30) Foreign Application Priority Data
Sep. 23, 1999 (DE) 199 45 668.2

(51) Int. Cl. H01M 8/04; H01M 8/06; H01M 8/12; H01M 8/18

(52) U.S. Cl. 429/13; 429/17; 429/24; 429/21; 429/30; 429/32

(57) ABSTRACT

The fuel cell stack can be electrically cold started by simply applying a voltage to the electrodes of at least one cell, in combination with the introduction of hydrogen into the cathode chamber. The electrodes and the membrane are then rapidly heated electrically without corrosion problems.

### CROSS-REFERENCE TO RELATED APPLICATION

This application is a continuation of copending International application PCT/DE00/03178, filed Sep. 13, 2000, which designated the United States.

### BACKGROUND OF THE INVENTION

1. Field of the Invention

The invention lies in the fuel cell technology field. More specifically, the invention relates to a method for starting a fuel cell stack comprising a plurality of fuel cell units, wherein at least one fuel cell unit is uniformly and rapidly brought to operating temperature. The invention also relates to an associated system with means for carrying out the method.

In the prior art PEM fuel cell stacks, the cold start, i.e. starting up the installation after a prolonged idle phase, is one of the problems which have not yet been resolved. This is particularly true of the conventional PEM fuel cell, specifically both the hydrogen-operated fuel cell and the direct methanol fuel cell, and also, in particular, the high-temperature PEM (HTM) fuel cell, for example a fuel cell of this type which, as its electrolyte, contains phosphoric acid, which has a freezing point of over 40° C.

Commonly assigned, copending patent application 09/968,305 (cf. German patent application 199 14 249.1) proposes a method for the cold starting of a fuel cell installation, wherein first of all a heater wire which is introduced into at least one cell is used, by flow of current and resistance heating, to heat up a minimal area of the cell, before autothermal heating of the cell is effected by the waste heat of the fuel cell reaction. A drawback of that method is that the cell is not heated uniformly and that an additional heater wire has to be incorporated in the cell.

The most simple option for cold starting a fuel cell is to apply voltage from an electric battery as the source, the resistance leading to a flow of current, and the resulting current generating a voltage drop at the resistor. The voltage drop produces waste heat, which can be used to heat the cell. Particularly in the case of PEM fuel cells with reaction chambers at the electrodes and a catalyst and carbon paper specifically at the anode, oxygen deposition will occur in the cold state, primarily at the positive electrode, with superimposed corrosion of the carbon paper, of the catalyst and of the electrode holder. The corrosion is disadvantageous and may, in particular, destroy the fuel cell.

### SUMMARY OF THE INVENTION

It is accordingly an object of the invention to provide a method and a system for starting a fuel cell stack in a fuel cell plant, which overcomes the above-mentioned disadvantages of the heretofore-known devices and methods of this general type and which provides for an improved method for starting a fuel cell stack and an associated fuel cell installation.

With the foregoing and other objects in view there is provided, in accordance with the invention, a method for starting a fuel cell stack formed of at least one fuel cell unit having an anode, a cathode, and a reaction chamber each, wherein the at least one fuel cell unit is uniformly and rapidly brought to operating temperature, the method which comprises the following method steps:

applying an electric voltage to at least one fuel cell unit;

interrupting a supply of oxidizing agent to the fuel cell unit, and substantially only supplying hydrogen;

and thereby causing substantially only hydrogen to be available in both reaction chambers of the fuel cell, so that hydrogen is consumed at the anode and hydrogen is generated at the cathode.

In other words, according to the invention, to start a fuel cell stack, a voltage is applied to at least one fuel cell of the stack and only hydrogen is available in the two reaction chambers of the cell. Hydrogen is consumed at the anode and hydrogen is generated at the cathode.

Therefore, in the invention the cathode gas flow is advantageously combined with the anode gas flow, so that the hydrogen which is generated at the cathode is consumed at the anode.

In accordance with an added feature of the invention, during cold starting of the fuel cell stack, an anode gas flow and a cathode gas flow are combined such that hydrogen forming at the cathode is consumed at the anode.

In accordance with an additional feature of the invention, electric current for starting the stack is at least partially supplied from an electrical energy store, such as a battery or the like. In an alternative embodiment, the electric current for starting the stack may be provided from an external mains connection.

In accordance with another feature of the invention, when a load is switched off, a supply of oxidizing agent to the cathode chamber of the fuel cell is interrupted. In that case, the cathode chamber is purged with residual anode gas when the load is switched off.

In accordance with a further feature of the invention, the method comprises measuring a current temperature or a temperature distribution in the at least one fuel cell of the stack with at least one temperature sensor connected to a control unit, and, after a predetermined or calculated temperature has been reached, and automatically stopping a supply of hydrogen to the cathode and opening the oxidizing agent feed line to the cathode chamber with the control unit.

Withy the above and other objects in view there is also provided, in accordance with the invention, a fuel cell installation, comprising a fuel cell stack with at least one fuel cell unit having an anode, a cathode, and a reaction chamber each, at least one temperature sensor disposed to measure a temperature in the fuel cell, and a control unit connected to the temperature sensor for controlling reaction gases for the fuel cell unit. The control unit is thereby configured to carry out the above-outlined method.

In accordance with yet an added feature of the invention, the fuel cell installation has reaction gas lines with switching devices connected to the control unit for controlling the reaction gases.

In accordance with a concomitant feature of the invention, the fuel cells are a part of an HTM fuel cell installation.

Other features which are considered as characteristic for the invention are set forth in the appended claims.

Although the invention is described herein as embodied in a method and a system for starting a fuel cell stack of a fuel cell installation, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

The starting point for the exemplary embodiments is a conventional prior art PEM fuel cell.

### DESCRIPTION OF THE PREFERRED EMBODIMENTS

A PEM (polymer electrolyte membrane) fuel cell installation includes a multiplicity of fuel cell units, which are positioned in layers to form a fuel cell stack. The term stack is understood to mean a stacked arrangement comprising at least one fuel cell unit. A fuel cell unit comprises a membrane electrode assembly (MEA) with electrical lines, respectively adjacent reaction chambers, an anode chamber and a cathode chamber, and corresponding gas supply lines.

If the PEM fuel cell is to be operated at elevated temperatures, i.e. as an HT-PEM fuel cell or more generally as an HTM fuel cell, the problem of cold starting arises if the fuel cell is to be fully operational as quickly as possible. This is achieved by applying a voltage to one or more fuel cell units. At the same time, the supply of oxygen as oxidizing agent for the fuel cell is interrupted, and therefore only hydrogen is fed in. As a result, only hydrogen is available in both reaction chambers of the fuel cell. This means that hydrogen is consumed at the anode, whereas hydrogen is formed at the cathode. By suitably combining the gas flows at the anode and at the cathode, the hydrogen formed at the cathode is consumed, with heat being liberated. This heat is used to heat the fuel cell stack to operating temperature.

The proposed procedure means that, when current is flowing, there is no electrolysis or deposition of oxygen, which would lead to corrosion of the catalyst support, of the carbon powder, and/or of the carbon paper. Rather, hydrogen is pumped, so that heat is supplied as a result of the proton migration, the flow of current at the two electrodes and/or the polarization of the electrodes.

According to one embodiment of the method, the current for starting the stack is at least partially taken from an energy store, such as for example a battery and/or a capacitor, which, by way of example, has been charged during the last operating period of the installation.

According to one embodiment, the current required to start the stack originates at least partially from an external mains connection.

According to one embodiment of the method, the supply of the oxidizing agent to the cathode chamber of the fuel cell is interrupted even while the load is being switched off. In this embodiment, it is preferable for the cathode chamber to be purged with residual anode gas while the load is being switched off.

According to one configuration, there is at least one temperature sensor, which measures the current temperature and/or temperature distribution in a cell and/or in the stack and is connected to a control unit, the control unit automatically stopping the supply of hydrogen to the cathodes and opening the lines for supplying oxidizing agent to the cathode chambers again, so that standard fuel cell operation commences, after a predetermined or calculated temperature, such as the operating temperature or a minimum temperature which ensures autothermal heating takes place.

Depending on requirements, a stack also comprises a cooling system or part of a cooling system.

The invention allows electrical cold starting of a stack by simply applying voltage to the electrodes of at least one cell in combination with the introduction of hydrogen into the cathode chamber. The electrodes and the membrane are then rapidly heated electrically without corrosion problems occurring.

I claim:

1. A method for starting a fuel cell stack formed of at least one fuel cell unit having an anode, a cathode, and a reaction chamber each, wherein the at least one fuel cell unit is uniformly and rapidly brought to operating temperature, the method which comprises the following method steps:
applying an electric voltage to at least one fuel cell unit;
interrupting a supply of oxidizing agent to the fuel cell unit, and substantially only supplying hydrogen;
and thereby causing substantially only hydrogen to be available in both reaction chambers of the fuel cell, so that hydrogen is consumed at the anode and hydrogen is generated at the cathode.

2. The method according to claim 1, which comprises, during cold starting of the fuel cell stack, combining an anode gas flow and a cathode gas flow such that hydrogen forming at the cathode is consumed at the anode.

3. The method according to claim 1, which comprises at least partially supplying electric current for starting the stack from an electrical energy store.

4. The method according to claim 1, which comprises at least partially supplying electric current for starting the stack from a battery.

5. The method according to claim 1, which comprises at least partially supplying electric current for starting the stack from an external mains connection.

6. The method according to claim 1, which comprises, when a load is switched off, interrupting a supply of oxidizing agent to the cathode chamber of the fuel cell.

7. The method according to claim 6, which comprises purging the cathode chamber with residual anode gas when the load is switched off.

8. The method according to claim 1, which comprises measuring a temperature in the at least one fuel cell of the stack with at least one temperature sensor connected to a control unit, and, after a predetermined or calculated temperature has been reached, and automatically stopping a supply of hydrogen to the cathode and opening the oxidizing agent feed line to the cathode chamber with the control unit.

9. The method according to claim 8, wherein the step of measuring the temperature comprises measuring an instantaneous temperature in the at least one fuel cell of the stack.

10. The method according to claim 8, wherein the step of measuring the temperature comprises measuring a temperature distribution in the at least one fuel cell of the stack.

11. A fuel cell installation, comprising a fuel cell stack with at least one fuel cell unit having an anode, a cathode, and a reaction chamber each, at least one temperature sensor disposed to measure a temperature in said fuel cell, and a control unit connected to said temperature sensor for controlling reaction gases for the fuel cell unit, said control unit being configured to carry out the method according to claim 1.

12. The fuel cell installation according to claim 11, which comprises reaction gas lines having switching devices connected to said control unit for controlling the reaction gases.

13. The system according to claim 11, wherein said fuel cell stack is a part of an HTM fuel cell installation.
